(19) United States
(12) Patent Application Publication
(10) Pub. No.: US 2024/0177696 A1
(43) Pub. Date: May 30, 2024

(54) SOUND GENERATION DEVICE, SOUND GENERATION METHOD, AND RECORDING MEDIUM

(71) Applicant: YAMAHA CORPORATION, Hamamatsu-shi (JP)

(72) Inventor: Shinichi ITO, Hamamatsu-shi (JP)

(21) Appl. No.: 18/430,807

(22) Filed: Feb. 2, 2024

Related U.S. Application Data
(63) Continuation of application No. PCT/JP2022/031073, filed on Aug. 17, 2022.

(30) Foreign Application Priority Data
Sep. 1, 2021 (JP) 2021-142351

(51) Int. Cl. G10H 1/00

(52) U.S. Cl. CPC G10H 1/0008; G10H 2220/111; G10H 2240/115

(57) ABSTRACT

A sound generation device includes: at least one memory storing instructions; and at least one processor that executes the instructions to: output an output sound signal representing a performance based on performance data including a plurality of tracks each including at least one sound signal including an attribute; designate attribute information of the attribute of at least one of the at least one sound signal of at least one of the plurality of tracks as a search target; and search for a sound signal including the designated attribute information from the performance data. The performance in the output sound signal includes, omits, or changes the searched sound signal.

### CROSS-REFERENCE TO RELATED APPLICATIONS

The present application is a continuation application of International Application No. PCT/JP2022/031073, filed Aug. 17, 2022, which claims priority to Japanese Patent Application No. 2021-142351, filed Sep. 1, 2021. The contents of these applications are incorporated herein by reference.

### BACKGROUND

### Technical Field

The present disclosure relates to a sound generation device, a sound generation method, and a recording medium.

### Background Art

There is automatic performance data that stores sound signals corresponding to the sounds (tones) of various musical instruments. In restaurants that offer live musical performance, the sound output during automatic performance may be changed depending on the composition of band members that can participate. For example, if some members are absent, the automatic performance is set to output tones (voices) corresponding to the instruments that the members were scheduled to play. Alternatively, the automatic performance may mute the sound of an instrument of the same type as that played by a member. Japanese Unexamined Patent Application, First Publication No. H10-124057 discloses a technique that enables to suppress the sound volume of a specific musical instrument sound. Japanese Unexamined Patent Application, First Publication No. H08-30284 discloses a technique for muting a designated part among the parts to be played.

### SUMMARY OF INVENTION

However, automatic performance data are often stored in a state in which sound signals corresponding to a plurality of tones are mixed irregularly. For example, one track may contain sound signals corresponding to a plurality of tones. Moreover, even if one track contains only sound signals corresponding to one tone, the tone included in the track may differ depending on the song. Even within the same track, a guitar tone may be assigned in one song, and a piano tone may be assigned in another song. As a result, when attempting to search for the tone of a specific musical instrument from automatic performance data, it was necessary to manually mute or output each sound signal, which was time-consuming, while checking, for each song, detailed information such as which tone was assigned to which track, or checking, for each track, detailed information such as whether it is a track to which one tone was assigned or whether it is a track to which a plurality of tones were assigned.

The present disclosure takes into consideration the above circumstances, and an example object of the present disclosure is to provide a sound generation device, a sound generation method, and a recording medium capable of searching for a sound signal corresponding to the sound of a musical instrument, from performance data in which each of a plurality of tracks includes one or more sound signals each having attribute information.

In order to solve the above problems, an aspect of the present disclosure is a sound generation device including: at least one memory storing instructions; and at least one processor that executes the instructions to: output an output sound signal representing a performance based on performance data including a plurality of tracks each including at least one sound signal including an attribute; designate attribute information of the attribute of at least one of the at least one sound signal of at least one of the plurality of tracks as a search target; and search for a sound signal including the designated attribute information from the performance data. The performance in the output sound signal includes, omits, or changes the searched sound signal.

Moreover, an aspect of the present disclosure is a sound generation method executed by a computer. The method includes: outputting an output sound signal representing a performance based on performance data including a plurality of tracks each including at least one sound signal including an attribute; designating attribute information of the attribute of at least one of the at least one sound signal of at least one of the plurality of tracks as a search target; and searching for a sound signal including the designated attribute information from the performance data. The performance in the output sound signal includes, omits, or changes the searched sound signal.

Furthermore, an aspect of the present disclosure is a non-transitory computer-readable recording medium that stores a program executable by a computer to execute a method including: outputting an output sound signal representing a performance based on performance data including a plurality of tracks each including at least one sound signal each including an attribute; designating attribute information of the attribute of at least one of the at least one sound signal of at least one of the plurality of tracks as a search target; and searching for a sound signal including the designated attribute information from the performance data. The performance in the output sound signal includes, omits, or changes the searched sound signal.

### BRIEF DESCRIPTION OF THE DRAWINGS

FIG. 1 is a block diagram showing a configuration example of a sound output device 1 of an embodiment.

FIG. 2 is a diagram showing an example of performance data 120 of the embodiment.

FIG. 3 is a diagram showing an example of the performance data 120 of the embodiment.

FIG. 4 is a diagram showing an example of the performance data 120 of the embodiment.

FIG. 5 is a diagram showing an example of the performance data 120 of the embodiment.

FIG. 6 is a diagram showing an example of registration data 121 of the embodiment.

FIG. 7 is a diagram showing an example of the registration data 121 of the embodiment.

FIG. 8 is a diagram showing an example of category data 122 of the embodiment.

FIG. 9 is a diagram showing an example of the category data 122 of the embodiment.

FIG. 10 is a diagram showing an example of search target data 123 of the embodiment.

FIG. 11 is a diagram showing an example of the search target data 123 of the embodiment.

FIG. 12 is a diagram showing an example of images displayed on a display unit 15 of the embodiment.

FIG. 13 is a diagram showing a processing flow of the sound output device 1 of the embodiment.

FIG. 14 is a diagram showing a processing flow of the sound output device 1 of the embodiment.

FIG. 15 is a diagram for describing an example of the sound output device 1 of the embodiment.

FIG. 16 is a diagram for describing an example of the sound output device 1 of the embodiment.

### DETAILED DESCRIPTION OF THE EMBODIMENTS

Hereinafter, embodiments of the present disclosure will be described, with reference to the drawings.

A sound output device (sound generation device) 1 in an embodiment is a computer, for example, an electronic musical instrument. The sound output device 1 outputs electronic sounds corresponding to the notes played on the basis of performance data. The performance data is, for example, data generated on the basis of the MIDI (Musical Instrument Digital Interface) standard. For example, the sound output device 1 is used as a device that outputs accompaniment sounds and the like according to performance of the band.

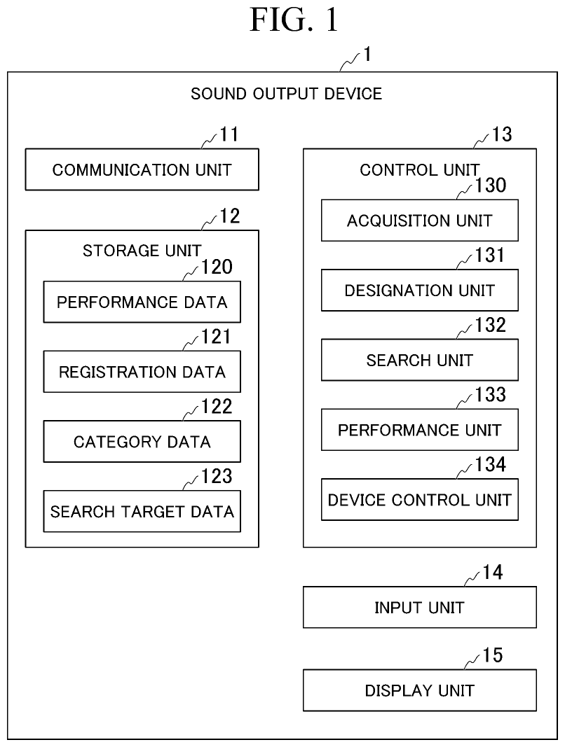

FIG. 1 is a block diagram showing a configuration example of the sound output device 1 of the embodiment. The sound output device 1 includes, for example, a communication unit 11, a storage unit 12, a control unit 13, and an input unit 14.

The communication unit 11 communicates with external devices. For example, the communication unit 11 receives various information such as performance data stored in an external server device via the Internet. Alternatively, the communication unit 11 acquires performance data stored in a portable memory such as a USB memory via a USB (Universal Serial Bus) interface or the like.

The storage unit 12 is configured, for example, with a storage medium such as a HDD (Hard Disk Drive), a flash memory, an EEPROM (Electrically Erasable Programmable Read Only Memory), a RAM (Random Access read/write memory), and a ROM (Read Only Memory), or with a combination of any of these storage media. The storage unit 12 stores a program for executing various processes of the sound output device 1, and temporary data used when performing the various processes. The storage unit 12 stores, for example, performance data 120, registration data 121, category data 122, and search target data 123.

Here, the performance data 120 will be described. The performance data 120 includes a plurality of tracks. Each of the plurality of tracks includes one or more sound signals. Each of the one or more sound signals has attribute information. The attribute information here is information indicating the kind of the sound that is output based on a sound signal, such as a tone, the number or symbol associated with the tone, and a character sequence (such as electric guitar) indicating the musical instrument indicated by the tone. Attribute information is a piece of information that can be set in, for example, a MIDI program change or a MIDI control change. For example, the performance data 120 includes one track including a plurality of sound signals each having one different tone as attribute information, and one track including a sound signal having one tone as attribute information.

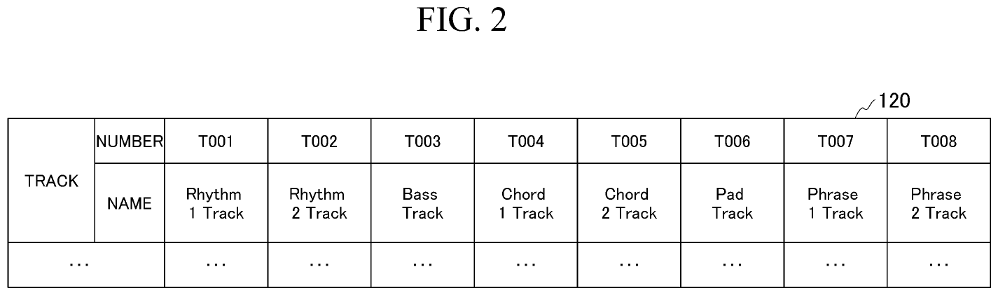

FIG. 2 to FIG. 5 are diagrams showing examples of the performance data 120 of the embodiment. The performance data 120 stores sound signals corresponding to a song to be automatically performed. As shown in the example of FIG. 2, the performance data 120 stores information corresponding to items such as track numbers and track names. The track number is a number that allows each track to be identified. The track name is the name of the track specified by the track number, and is, for example, the name of each performance part.

In the example of FIG. 2, the performance data 120 is composed of eight tracks numbered from track number (T001) to track number (T008). Track numbers T001 and T002 are associated with names “Rhythm 1 (Rhythm 1 Track)” and “Rhythm 2 (Rhythm 2 Track)”, respectively. Track number T003 is associated with a name “Bass (Bass Track)”. Track numbers T004 and T005 are associated with names “Chord 1 (Chord 1 Track)” and “Chord 2 (Chord 2 Track)”, respectively. Track number T006 is associated with a name “Pad (Pad Track)”. Track numbers T007 and T008 are associated with names “Phase 1 (Phase 1 Track)” and “Phase 2 (Phase 2 Track)”, respectively.

In general, each track of “Rhythm 1” and “Rhythm 2” mainly stores a percussion instrument tone such as drums and percussion. In general, the track of “Bass” stores a bass tone. In general, each track of “Chord 1” and “Chord 2” stores a chord tone such as a guitar chord and a piano chord. In general, the track of “Pad” stores a strings-type (stringed musical instrument) tone. In general, each track of “Phase 1” and “Phase 2” stores a guitar tone or a synthesizer tone, for example.

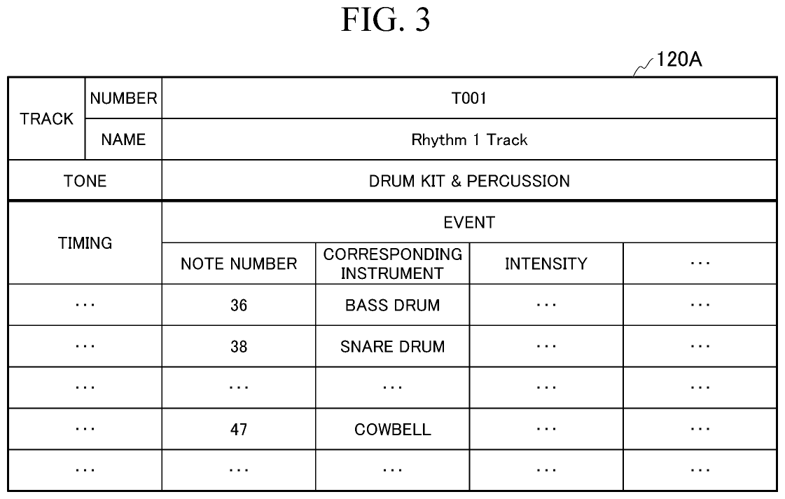

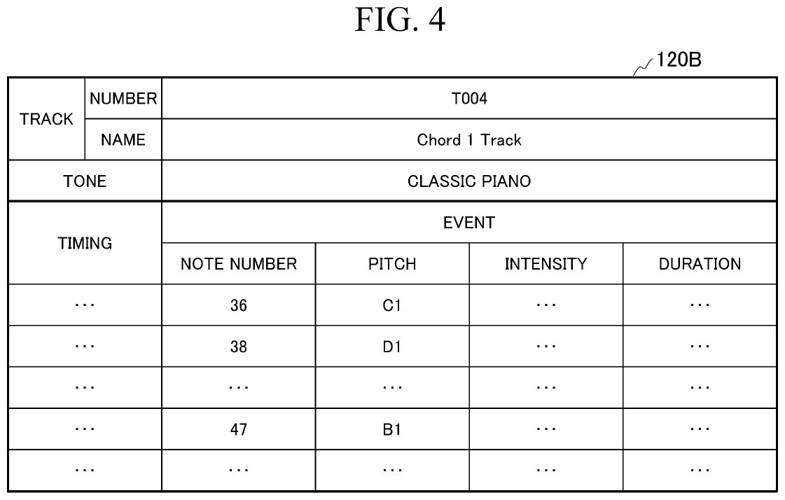

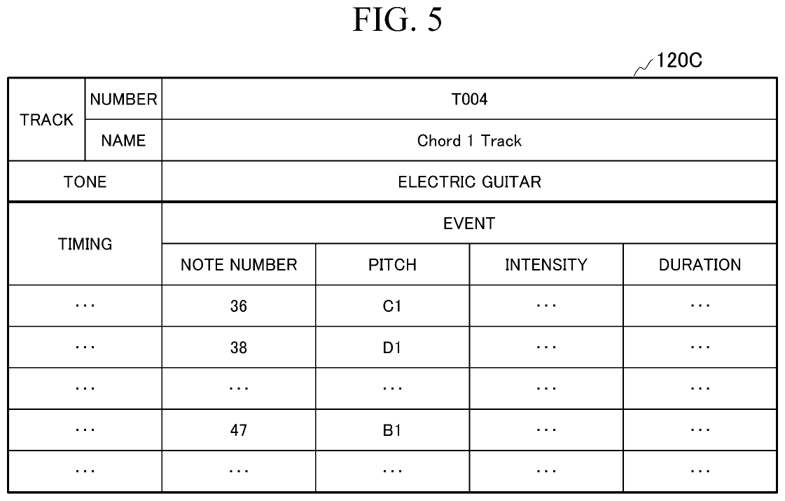

FIG. 3 to FIG. 5 show examples of data stored in each track making up the performance data 120 in FIG. 2. FIG. 3 shows an example of “Rhythm 1” data stored in track number T001. FIG. 4 and FIG. 5 show examples of “Chord 1” data stored in track number T004

As shown in FIG. 3, the “Rhythm” track stores information corresponding to items such as track number, track name, tone, and timing. The track name field stores a name corresponding to the track name in FIG. 2. The tone field stores the tone of the sound signal assigned to the track.

The example of FIG. 3 shows that to the track named “Rhythm 1” there is assigned a sound signal having each tone of an instrument group corresponding to “Drum kit & percussion” as attribute information. In this manner, the rhythm data in the the performance data 120 includes sound signals mainly having the tones of percussion instruments as attribute information. Examples of percussion instruments include a musical instrument set included in a drum kit such as a bass drum and a snare drum, and a cowbell. It should be noted that to the rhythm track there may be assigned a sound such as laughter, or a tone of a percussion instrument other than those for Western music, such as a Japanese drum, as attribute information.

The timing field stores information indicating the elapsed time on the basis of the performance start time. Events are associated with timings. An event is a piece of information indicating the specific content of a process executed as a performance. The event includes items such as note number, corresponding instrument, and intensity, and each of these items is associated with information. The note number is a number preliminarily set to each key on the keyboard. The corresponding instrument stores information indicating the musical instrument (percussion instrument) associated with the key specified by the note number. Since percussion instruments have no pitch, one instrument is associated with one key. It should be noted that in cases where there are multiple performance methods corresponding to one percussion instrument, the multiple performance methods may be assigned to different keys.

The example of FIG. 3 shows that the sound signal of “bass drum”, an instrument corresponding to note number 36, is output at a certain timing, and the sound signal of “snare drum”, an instrument corresponding to note number 38, is output at the next timing. The example of FIG. 3 also shows that the sound signal of “cowbell”, an instrument corresponding to note number 47, is output at another timing.

As shown in FIG. 4 and FIG. 5, the “Chord” track, as with the “Rhythm” track, includes items such as track number, track name, tone, and timing, and stores information corresponding to each item. On the other hand, the “Chord” track is different from the “Rhythm” track. Specifically, in the “Chord” track, the event includes items such as note number, pitch, intensity, and duration, and stores information corresponding to each of these items. The “Chord” track stores a sound signal having as attribute information, the tone of a musical instrument having a pitch, such as a guitar or piano. Therefore, in the “Chord” track, one pitch is associated with one key.

The example of FIG. 4 shows that the tone of “classic piano” is assigned to the track named “Chord 1”. At one timing, a sound signal corresponding to the classic piano tone of “C1”, which is note number 36, is output, and at the next timing, a sound signal corresponding to the classic piano tone of “D1”, which is note number 38, is output. The example also shows that at another timing, a sound signal corresponding to the classic piano tone of “B1”, which is note number 47, is output.

The example of FIG. 5 shows that the tone of “electric guitar” is assigned to the track named “Chord 1”. At one timing, a sound signal corresponding to the electric guitar tone of “C1”, which is note number 36, is output, and at the next timing, a sound signal corresponding to the electric guitar tone of “D1”, which is note number 38, is output. The example also shows that at another timing, a sound signal corresponding to the electric guitar tone of “B1”, which is note number 47, is output.

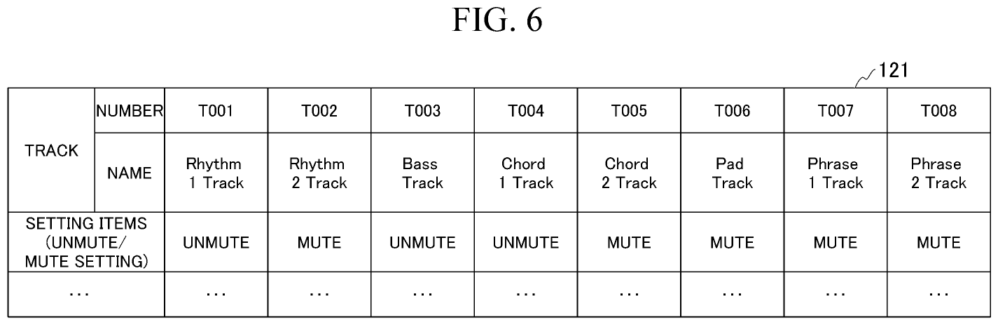

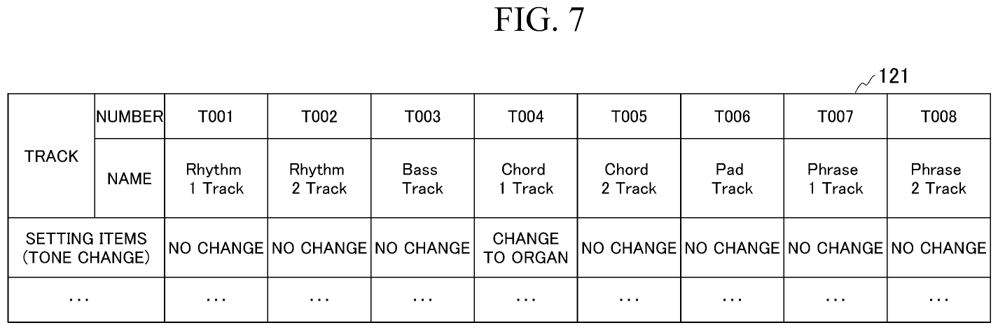

Here, the registration data 121 will be described, with reference to FIG. 6 and FIG. 7. FIG. 6 and FIG. 7 are diagrams showing examples of the registration data 121 of the embodiment. The registration data 121 is a set of data in which the sound signal output mode stored in the track is set for each track. The registration data 121 may have a data structure similar to that of the performance data 120.

The sound signal output mode set in the registration data 121 is, for example, a mode of whether or not to mute sound signals. Another example of the sound signal output mode is a mode that determines which musical instrument is set as the musical instrument corresponding to a sound signal. The registration data 121 is used, for example, when arranging a song stored in the performance data 120. As a result, it is possible to carry out a performance with a different atmosphere, for example, by having a song be played with a different musical instrument than in the normal performance, or by making the song quieter than the normal performance. Furthermore, by storing the sound signal output mode as the registration data 121, it is possible to change the sound signal output mode to a preset desired output mode during a performance.

The registration data 121 includes, for example, information associated with items such as track numbers, track names, and setting items. The track number and track name are the same information as the information included in the performance data 120. Therefore, the description of these will be omitted. In the setting item, the sound signal output mode is set.

In the example of FIG. 6, sound unmute/mute setting is associated as a setting item. The sound unmute/mute setting field stores information for setting whether the sound signal is to be unmuted or muted. For example, when outputting sound signals, “unmuted” is set in the sound unmute/mute setting. When muting sound signals, “muted” is set in the sound unmute/mute setting.

In the example of FIG. 7, tone change is associated as a setting item. The tone change field stores information for setting whether or not to change the tone assigned to a track. Moreover, the tone change field stores information for setting which tone to use if the tone is to be changed. The example in FIG. 7 shows a setting for changing the tone (classic piano) assigned to the “Chord 1” track, to the tone of a pipe organ.

As shown by the performance data 120 and the registration data 121, in general, performance data stores a sound signal in which each track has a tone corresponding to each performance part as attribute information. However, instruments used to perform each performance part vary depending on musical style. That is to say, as shown in FIG. 4, in some cases, the “Chord 1” track may store a sound signal having the classic piano tone as attribute information. On the other hand, as shown in FIG. 5, in some cases, the “Chord 1” track may store a sound signal having the electric guitar tone as attribute information.

In a band performance, in some cases, only the performance sound of a guitar part may be desired to be output from the automatic performance on a day where no guitar player is available. In such a case, it is conceivable to set a specific track to “unmute” and set other tracks to “mute.” Specifically, it is conceivable to set either “Chord 1” or “Chord 2”, both “Chord 1” and “Chord 2”, or either “Phase 1” or “Phase 2” in the performance data to “unmute”, and other tracks to “mute”. However, depending on the musical style, the track containing the sound signal having a guitar tone as attribute information may be different. For example, a sound signal having a guitar tone as attribute information may be included in “Chord 1” in one style, and “Chord 2” in another style. Therefore, in the case where no guitar player is available, simply setting a specific track to “unmute” will not allow only the intended guitar performance sound to be output.

Regarding drums and the like, as shown in FIG. 3, a main drum sound signal is included in the “Rhythm 1” track, but the same track may also contain a sound signal that has percussion tone as attribute information. Furthermore, the “Rhythm 2” track may also contain a sound signal having the tone of some instruments in a drum kit as attribute information. On a day where a drum player is available and only the drum part is desired to be muted from automatic performance, if the “Rhythm 1” track is muted (OFF), the cowbell tone that belongs to percussion will also be muted. Also, if the “Rhythm 2” track is left set unmuted (ON), some of the drum kit tones will be output.

Furthermore, the sound unmute/mute setting for each track in performance data can be stored in the registration data 121. Registration data also includes musical style and tone selections. A plurality of sets of registration data may be used for one song in some cases.

For example, assume that four types of registration data are used for each song, and that a band is scheduled to perform 20 songs tonight. In such a case, 80 (−20 [songs]×4 [types]) sets of registration data are to be used. If no guitar player is available for tonight's performance, rewriting all 80 pieces of registration data will be a very time-consuming and labor-intensive task.

As a countermeasure for this, in the present embodiment, as a function separate from the registration data setting, there is implemented an output control function capable, for each musical instrument associated with a sound signal included in the performance data, of setting the sound signal to be output or muted.

Here, the output control function will be described. Returning to FIG. 1, the control unit 13 is implemented by causing the CPU (Central Processing Unit) included as a hardware unit in the sound output device 1, to execute a program stored in the storage unit (memory) 12. The control unit 13 includes, for example, an acquisition unit 130, a designation unit 131, a search unit 132, a performance unit 133, and a device control unit 134. These functional units included in the control unit 13 realize the output control function.

The acquisition unit 130 acquires various information. For example, the acquisition unit 130 acquires performance data received by the communication unit 11, and stores the acquired performance data in the storage unit 12 as the performance data 120. The performance data is a piece of information in which a plurality of tracks include a plurality of sound signals having attribute information.

Moreover, when the user operates the input unit 14 such as a selection button or dial key, the acquisition unit 130 acquires information indicating the operation contents via the input unit 14, and outputs the acquired information to the device control unit 134.

The designation unit 131 designates a search target. The search target here is a sound signal having specific attribute information in the performance data. In the following, a case where attribute information is a piece of information indicating a tone will be described as an example. In such a case, the search target is a sound signal having a specific tone as attribute information. The attribute information (tone) may be a piece of information indicating the type of sound (type of sounding body).

For example, the designation unit 131 acquires the tone selected by the user, and, as a search target, designates a sound signal having the acquired tone as attribute information. For example, the designation unit 131 causes the display unit 15 to selectably display tones used in the performance data. The user performs an operation to select one of the tones displayed on the display unit 15 by operating a dial key or the like. The input unit 14 acquires the tone selected by the user and outputs it to the acquisition unit 130. The designation unit 131 acquires the tone selected by the user via the acquisition unit 130, and outputs the acquired tone as attribute information to the search unit 132. The designation unit 131 thereby designates the search target.

Further, the designation unit 131 may specify the category to which the attribute information specified as the search target belongs, and specify the search target according to the specified category.

The category here is a classification that divides attribute information into several groups. For example, a category is a classification of musical instruments (drums, percussion, bass, guitar, piano, and so forth) played in a band performance. One category includes a plurality of pieces of attribute information. For example, if the category is “guitar”, tone attribute information such as “acoustic guitar”, “electric guitar”, and “guitar harmonics” belongs to that category. Attribute information that corresponds not only to a tone but also to a performance method such as a special performance technique may belong to a category. Moreover, if the category is “piano”, then tone attribute information such as “grand piano”, “classic piano”, and “electric piano” belongs to that category. The correspondence relationship between attribute information and categories is stored in the storage unit 12 as the category data 122, for example.

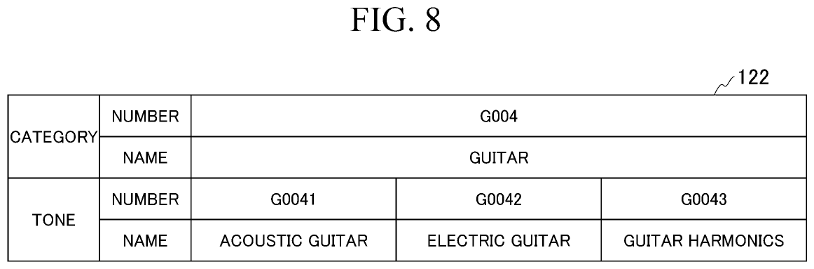

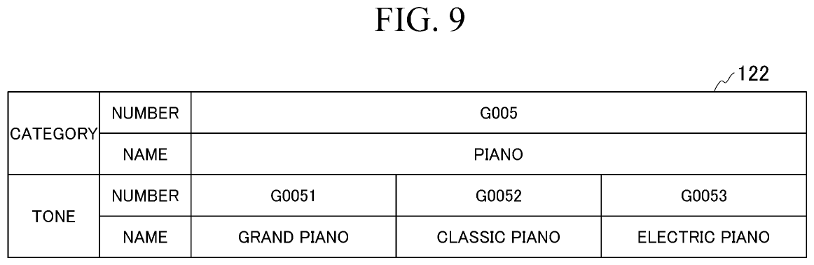

Here, the category data 122 will be described, with reference to FIG. 8 and FIG. 9. FIG. 8 and FIG. 9 are diagrams showing examples of the category data 122 of the embodiment. The category data 122 stores, for example, information corresponding to both category and tone. The category field is provided with items such as number and name, and stores information corresponding to each of these items. The category number field stores a number for identifying a category. In the category name field, the name of the category specified by the category number is stored. The tone field is provided with items such as number and name, and stores information corresponding to each of these items. The tone number field stores a number for identifying a tone. In the tone name field, the name of the tone specified by the tone number is stored.

FIG. 8 shows an example of the category data 122 when the category is guitar. In the example of FIG. 8, acoustic guitar, electric guitar, and guitar harmonics are associated as tones that belong to the guitar category. Guitar harmonics is an example of a special performance technique.

FIG. 9 shows an example of the category data 122 when the category is piano. In the example of FIG. 9, grand piano, classic piano, and electric piano are associated as tones that belong to the piano category.

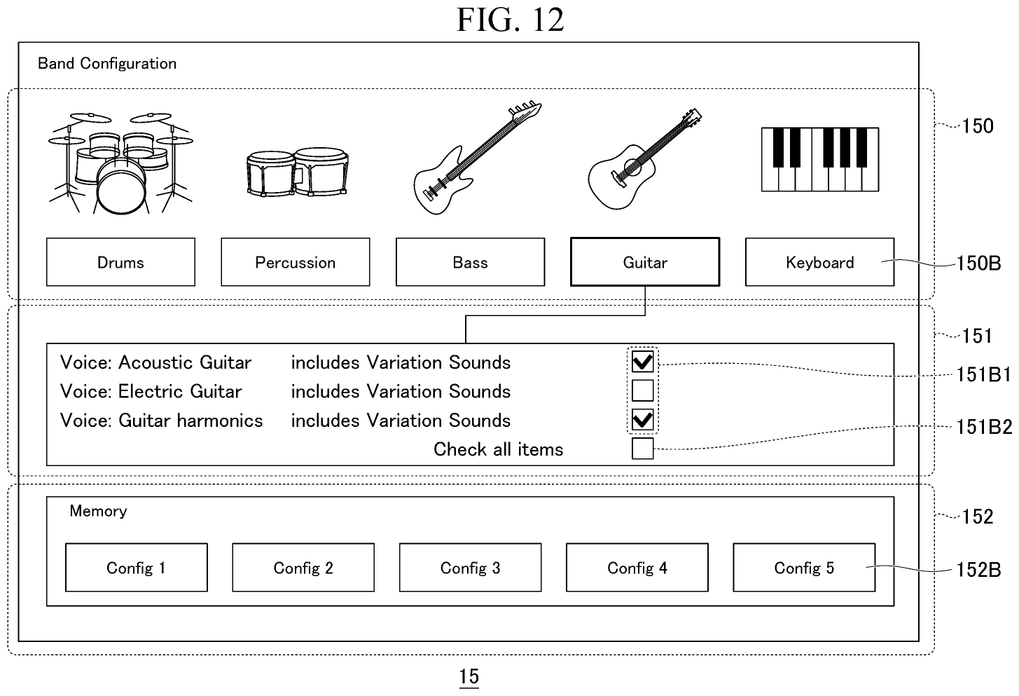

For example, the designation unit 131 acquires the category selected by the user, and, as a search target, designates a sound signal having the tone belonging to the acquired category as attribute information. In such a case, for example, the designation unit 131 causes the display unit 15 to selectably display icons of musical instrument categories, such as drums, percussion, bass, guitar, piano, and so forth (see image 150 in FIG. 12).

The user performs an operation to select one of the categories displayed on the display unit 15 by operating the dial key or the like. The input unit 14 acquires the category selected by the user and outputs it to the acquisition unit 130. The designation unit 131 acquires the category selected by the user via the acquisition unit 130, and specifies the tone belonging to the acquired category, using the category data 122. The designation unit 131 outputs the specified tone as attribute information to the search unit 132. The designation unit 131 thereby designates the search target.

Alternatively, the designation unit 131 may designate, as a search target, a sound signal having some of the tones among the plurality of tones belonging to the category.

In such a case, for example, the designation unit 131 causes the display unit 15 to selectably display musical instrument categories (see image 150 in FIG. 12). The designation unit 131 then acquires information indicating the category selected by the user, and specifies the tones belonging to the acquired category, using the category data 122. Based on the specified category, the designation unit 131 causes the display unit 15 to display tones (sounding bodies) belonging to the category. For example, when guitar is selected as the musical instrument category, the designation unit 131 displays tones belonging to the guitar category (see image 151 in FIG. 12).

The user operates the dial key or the like to perform an operation of selecting whether or not to use the sound signal having the displayed tone, as the search target. The input unit 14 acquires information indicating the tone selected as the search target by the user. The designation unit 131 then outputs the acquired information to the search unit 132 as information indicating the tone of the search target sound signal. The designation unit 131 thereby designates the search target.

The designation unit 131 may acquire the tone selected by the user, and, as a search target, designate another tone belonging to the category to which the acquired tone belongs. In such a case, for example, the designation unit 131 causes the display unit 15 to selectably display tones used in the performance data. The user operates the dial key or the like to perform an operation to select one (referred to as first tone) of the displayed tones. The designation unit 131 acquires the first tone selected by the user. The designation unit 131 specifies the category to which the acquired first tone belongs, using the category data 122. The designation unit 131 extracts other tones that belong to the specified category, using the category data 122. The designation unit 131 selectably displays the other extracted tones. The user operates the dial key or the like to perform an operation to select one (referred to as second tone) of the other tones displayed. The designation unit 131 acquires the second tone selected by the user. The designation unit 131 designates the acquired second tone as a search target together with the first tone.

Moreover, the designation unit 131 may cause the storage unit 12 to store attribute information designated as a search target, and category information indicating a category, as search target data 123.

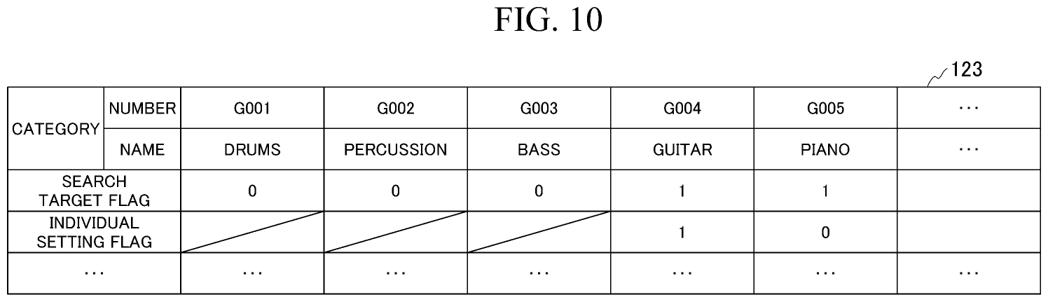

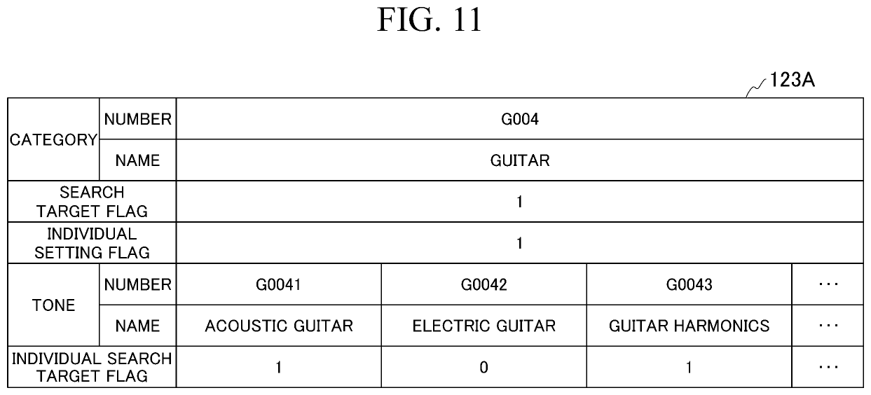

Here, the search target data 123 will be described, with reference to FIG. 10 and FIG. 11. FIG. 10 and FIG. 11 are diagrams showing examples of the search target data 123 of the embodiment.

In FIG. 10, for each category, it is shown whether to treat a sound signal having a tone belonging to that category as attribute information, as a search target. The search target data 123 stores, for example, information corresponding to items such as category number, category name, search target flag, and individual setting flag. The category field is provided with items such as number and name, and stores information corresponding to each of these items. The category number field stores a number for identifying a category. In the category name field, the name of the category specified by the category number is stored.

The search target flag field stores binary information indicating whether or not the category specified by a category number is a search target. For example, if the search target flag is set to 0 (zero), this indicates that it is not a search target. On the other hand, if the search target flag is set to 1, this indicates that it is a search target.

The individual setting flag field stores binary information individually indicating whether or not each of the sound signals having as attribute information a tone belonging to the category specified by a category number, is a search target. For example, if the individual setting flag is set to 0 (zero), this indicates not to individually specify whether or not to treat each of the tones belonging to the category, as a search target. On the other hand, if the individual setting flag is set to 1, this indicates to individually specify whether or not to treat each of the tones belonging to the category, as a search target.

The example of FIG. 10 shows whether or not the tone is a search target, concerning each of the drums, percussion, bass, guitar, and piano categories, which correspond respectively to category numbers G001 to G005. Here, this example shows that among the drums, percussion, bass, guitar, and piano categories, the guitar and piano categories are search targets. The example also shows that, of the guitar and piano categories, which are search targets, for the guitar category, each tone belonging to the guitar category is individually designated as to whether or not it is a search target. The example also shows that, for the piano category, each tone belonging to the piano category is not individually set as to whether or not to be treated as a search target, and all sound signals having a tone belonging to the piano category are treated as search targets.

FIG. 11 shows whether or not each tone belonging to the category is individually treated as a search target. Search target data 123A stores, for example, information corresponding to items such as category, search target flag, and individual setting flag. Information corresponding to these items is similar to that of the search target data 123. The search target data 123A further stores information corresponding to items such as tone, and individual search target flag.

The tone field is provided with items such as number and name, and stores information corresponding to each of these items. The tone number field stores a number for identifying a tone. In the tone name field, the name of the tone specified by the tone number is stored. The individual search target flag field stores information indicating whether or not it is treated as a search target. For example, if the individual search target flag is set to 0 (zero), this indicates that it is not a search target. On the other hand, if the individual search target flag is set to 1, this indicates that it is a search target.

In the example of FIG. 11 acoustic guitar, electric guitar, and guitar harmonics are shown as tones that belong to the guitar corresponding to category number G004. Among these tones belonging to the guitar category, acoustic guitar is indicated as being a search target. Electric guitar is indicated as not being a search target. Guitar harmonics is indicated as being a search target.

Returning to the description of FIG. 1, the search unit 132 searches for a sound signal having the tone that is designated as a search target, based on the information acquired from the designation unit 131.

For example, the search unit 132 acquires as performance data, the performance data 120 corresponding to the song to be performed. If registration data is set in the acquired performance data, the search unit 132 acquires the registration data 121. The search unit 132 reflects the settings of the registration data 121 on the performance data 120. Thereby, the performance data 120 becomes performance data that outputs the style and tones set in the registration data 121. The search unit 132 makes reference to each track of the performance data and acquires attribute information included in the sound signal output from each track.

For example, the search unit 132 makes reference to a rhythm track such as “Rhythm 1” or “Rhythm 2” and acquires a chord number indicated in an event associated with each predetermined timing. The search unit 132 determines whether or not the sound signal associated with the chord number is the search target sound signal. If the sound signal associated with the chord number is the sound signal having the search target attribute information, the search unit 132 extracts the sound signal as a search target.

For example, the search unit 132 makes reference to a non-rhythm track such as “Chord 1” and “Chord 2” and acquires the tone assigned to the track. The search unit 132 determines whether or not the tone assigned to the track is a tone having the search target attribute information. If the tone assigned to the track is the tone having the search target attribute information, the search unit 132 extracts all sound signals included in the track as search targets.

The search unit 132 outputs to the performance unit 133, information indicating the sound signals extracted from the performance data, as search targets.

The performance unit 133 carries out a performance based on the performance data. Based on the performance data, the performance unit 133, at a predetermined timing, executes the event associated with the predetermined timing. Specifically, the performance unit 133 generates a sound of the tone associated with the sound signal indicated by the event, and outputs the generated sound with the intensity and duration indicated by the event. The performance unit 133 thereby carries out a performance.

In the present embodiment, the performance unit 133 acquires sound signals associated with events associated with the same timing in each track of the performance data that reflects the settings of the registration data. If the acquired sound signal is a sound signal extracted as a search target by the search unit 132, the performance unit 133 mutes the sound signal without outputting it. On the other hand, if the acquired sound signal is not a search target, the performance unit 133 outputs the sound signal. Thereby, the sound output device 1 can perform a performance so as to output only the sounds of the non-search target tones, without outputting the sounds of the search target tones.

The device control unit 134 controls the sound output device 1 in a centralized manner. For example, the device control unit 134 acquires performance data received by the communication unit 11, and stores the acquired performance data in the storage unit 12 as performance data 120. Furthermore, the device control unit 134 acquires information input to the input unit 14 and outputs the acquired information to the designation unit 131. Thereby, the designation unit 131 can acquire the tone selected by the user as attribute information.

The input unit 14 acquires operation information performed by the user. Examples of the input unit 14 include an operation button, a dial key, and each key of a keyboard. When the user operates an operation button or the like, the input unit 14 acquires information indicating the operation, and outputs the acquired information to the device control unit 13.

The display unit 15 displays images. Examples of the display unit 15 include a liquid crystal display. The display unit 15 displays images according to the control of the control unit 13.

Here, the images displayed on the sound output device 1 will be described, with reference to FIG. 12. FIG. 12 is a diagram showing an example of the images displayed on the display unit 15 of the embodiment. As shown in FIG. 12, for example, the display unit 15 displays images 150 to 152 as selection images. In the image 150, along with images of basic musical instrument categories that make up a band, such as drums, percussion, guitar, and piano (keyboard), buttons 150B for making a selection from these categories are displayed as search candidates.

In the image 151, along with character sequences such as acoustic guitar, electric guitar, and guitar harmonics indicating the tones that belong to the musical instrument category selected on the image 150, buttons 151B are displayed for individually setting whether or not to include these tones as search targets. In such a case, in addition to the buttons 151B1 for performing setting individually, a button 151B2 may be displayed for selecting all tones belonging to the musical instrument category.

The image 152 displays buttons 152B that are operated to store the category selected as a search target and the tones selected as search targets among the tones belonging to the category.

The user selects a tone to search for, and operates a dial key or the like to press down the button 152B and perform a storing operation. When the storing operation is performed, the designation unit 131 makes reference to the search target data 123 associated with the button 152B that has been operated for storing. If there is no already stored information in the referenced search target data 123, the designation unit 131 stores in the search target data 123 the attribute information and category information selected as search targets on the selection image. When the buttons 151B1 are selected as shown in FIG. 12, the information shown in the search target data 123A in FIG. 11 is stored.

On the other hand, if information is already stored in the referenced search target data 123, the designation unit 131 displays in the selection image, for example, an image for prompting to “overwrite” the attribute information and category information selected on the selection image, or for prompting to “recall” the preliminarily stored information. If the user selects “overwrite”, the designation unit 131 stores in the search target data 123 the attribute information and category information selected as search targets on the selection image. If the user selects “recall”, the designation unit 131 selects on the selection image the tone stored in the search target data 123. As a result, the preliminarily stored tone is reflected in the selection image, so that the search target tone can be set based on the past history without the user having to individually select the tone.

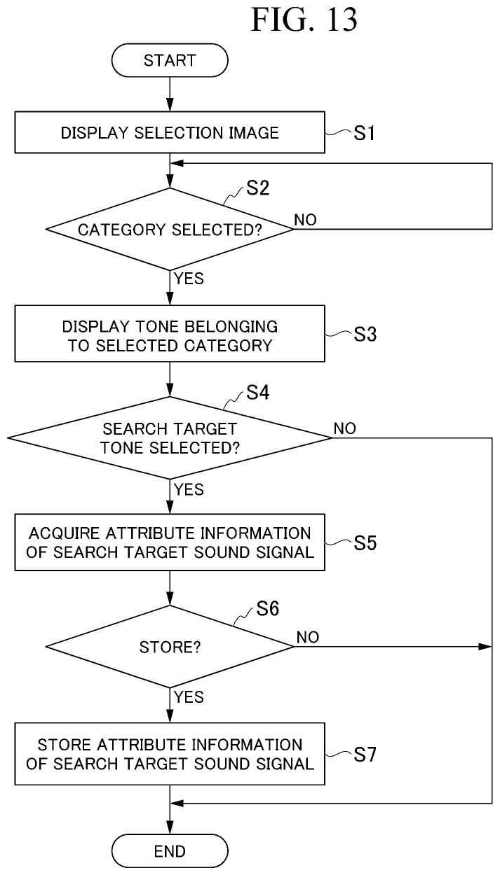

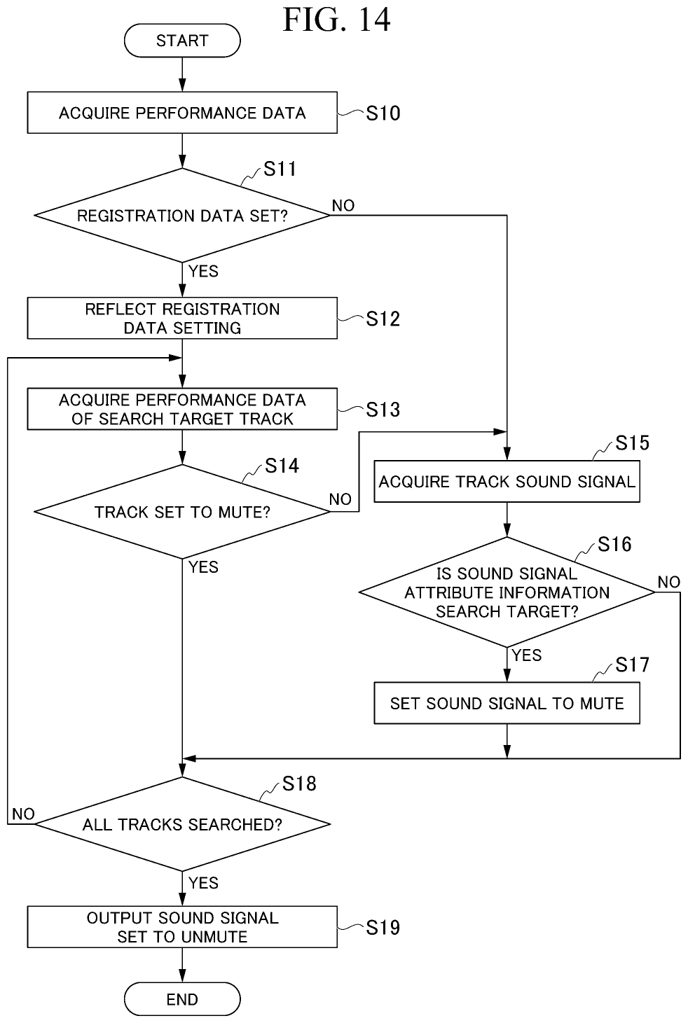

Here, the flow of processing performed by the sound output device 1 will be described, with reference to FIG. 13 and FIG. 14. FIG. 13 and FIG. 14 are diagrams showing flows of processing performed by the sound output device 1 of the embodiment. FIG. 13 shows the flow of processing for designating a search target. FIG. 14 shows the flow of processing for searching for a sound signal having the attribute information designated as a search target.

As shown in FIG. 13, the sound output device 1 displays the selection image (Step S1). The selection image displays categories of musical instruments that are search candidates. The sound output device 1 determines whether or not any of the musical instrument categories displayed in the selection image has been selected through an operation of the user (Step S2). If a category has been selected, the sound output device 1 acquires information indicating the selected category.

The sound output device 1 displays tones that belong to the category (Step S3). The sound output device 1 specifies the tones belonging to the musical instrument category selected through the user's operation, by making reference to the category data 122. The sound output device 1 displays in the selection image character sequences indicating the tones that belong to the specified category.

The sound output device 1 determines whether or not a tone displayed in the selection image has been selected through an operation of the user (Step S4). If a tone has been selected, the sound output device 1 acquires information indicating the selected tone as search target attribute information (Step S5).

The sound output device 1 determines whether or not to store the search target (Step S6). For example, if the user has performed a storing operation, the sound output device 1 determines to store the search target. On the other hand, if the user has not performed a storing operation, the sound output device 1 determines not to store the search target. When storing a search target, the sound output device 1 stores search target attribute information in the storage unit 12 as search target data 123 (Step S7). On the other hand, when not storing a search target, the sound output device l ends the processing.

As shown in FIG. 14, the sound output device 1 acquires the performance data 120 (Step S10). The sound output device 1 determines whether or not registration data 121 is set in the acquired performance data 120 (Step S11). If registration data 121 is set, the sound output device 1 reflects the registration data in the performance data 120 (Step S12). The sound output device 1 acquires performance data of the search target track (Step S13). The sound output device 1 determines whether or not the track is set to mute (Step S14). If muting is set, it is determined whether or not all tracks have been searched (Step S18), and if there are any tracks that have not been searched, the processing returns to Step S13. If all tracks have been searched, a sound signal set to unmuted is output (Step S19). As a result, the sound output device 1 outputs the sound of the tone associated with the sound signal.

On the other hand, in Step S14, if muting is not set for the track, the sound output device 1 acquires the sound signal set in the event for each timing in the track (Step S15). The sound output device 1 determines whether or not the attribute information associated with the acquired sound signal is a search target (Step S16). If it is a search target, the sound output device 1 sets the sound signal to mute (Step S17). If it is not a search target, the sound output device 1 executes the process shown in Step S18 without setting the sound signal to mute.

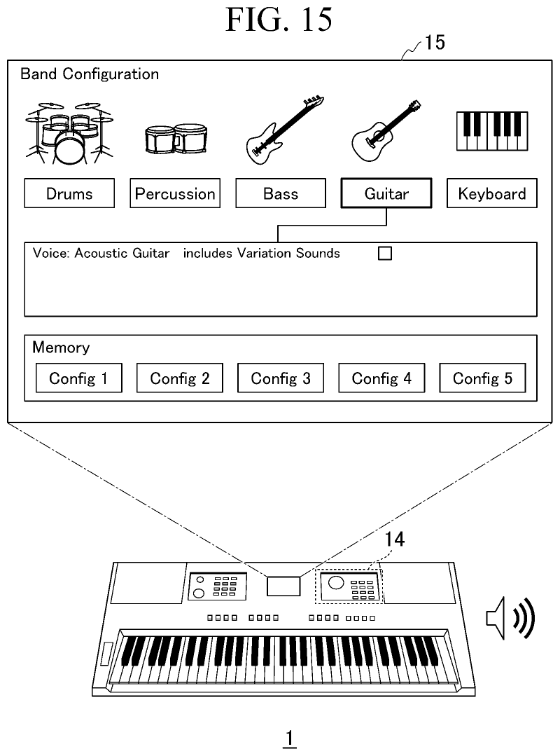

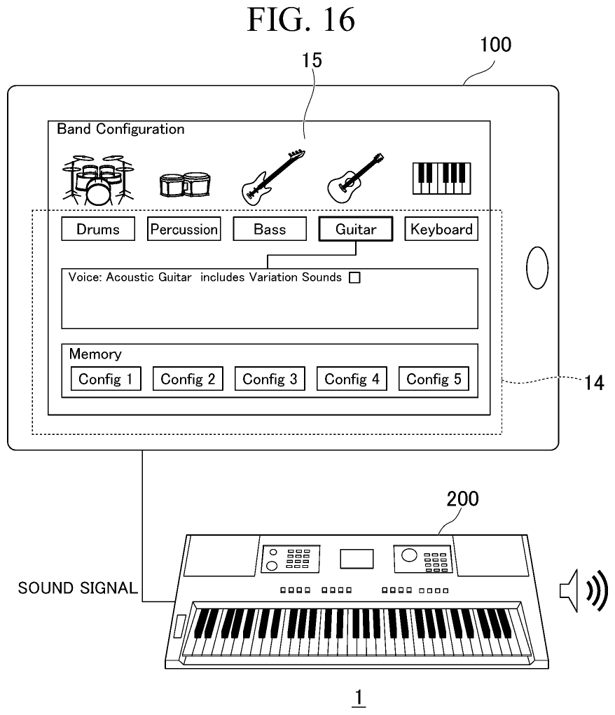

Here, an example to which the sound output device 1 is applied will be described, with reference to FIG. 15 and FIG. 16. FIG. 15 schematically shows an example in which the sound output device 1 is applied to an electronic musical instrument. In such a case, the selection button or dial key provided on the electronic musical instrument functions as the input section 14. Moreover, the liquid crystal display provided on the electronic musical instrument functions as the display unit 15.

The sound output device 1 may be a PC (Personal Computer), a server device, or a tablet terminal, that has a function of generating a waveform corresponding to a sound signal. FIG. 16 schematically shows an example in which the sound output device 1 is implemented with a tablet terminal 100 and an electronic musical instrument connected to the tablet terminal 100. In such a case, a touch panel provided on the tablet terminal functions as the input unit 14. Moreover, the liquid crystal display provided on the electronic musical instrument functions as the display unit 15. The tablet terminal 100 outputs sound signals to the electronic musical instrument 200. The tablet terminal 100 mutes and does not output the sound signal having a search target tone as attribute information, and causes the electronic musical instrument 200 to output only the sound signal having the non-search target tone as attribute information. The electronic musical instrument 200 outputs sound corresponding to the sound signal acquired from the tablet terminal 100.

In the embodiment described above, a case has been described in which a sound signal having a search target tone as attribute information is set to mute; however, the present disclosure is not limited to such an example. For example, the sound output device 1 can also be used when a sound signal having a search target tone as attribute information is unmuted and a sound signal having a non-search target tone as attribute information is muted.

As described above, the sound output device 1 (an example of a sound generation device) according to the embodiment includes the performance unit 133, the designation unit 131, and the search unit 132. The performance unit 133 carries out a performance based on performance data 120. The performance data 120 includes on a plurality of tracks, a plurality of sound signals having attribute information. The attribute information is, for example, a piece of information indicating which tone a sound signal has as attribute information. The designation unit 131 designates search target attribute information. The search unit 132 searches the performance data 120 for a sound signal having the attribute information designated by the designation unit 131. As a result, the sound output device 1 according to the embodiment can search for a sound signal having a specific tone as attribute information, from performance data in which sound signals having a plurality of tones as attribute information are mixed on a plurality of tracks. That is to say, it is possible to search for a sound signal corresponding to the sound of a specific musical instrument. Therefore, settings of automatic performance can be easily changed depending on the band members who are available to participate in a performance.

In the embodiment described above, a case has been described as an example in which the correspondence relationship between attribute information and category information is stored in the storage unit 12 as category data 122. However, the present disclosure is not limited to such an example. The correspondence relationship between attribute information and category information only needs to exist in such a mode that at least the designation unit 131 can specify the category to which a tone belongs, or specify the tone that belongs to a category.

For example, a sound signal may have attribute information and category information. In such a configuration, the correspondence relationship between attribute information and category information is stored in the storage unit 12 as information regarding a sound signal of the performance data 120. For example, the designation unit 131 makes reference to the performance data 120 to thereby specify the category to which a tone belongs. Alternatively, the designation unit 131 makes reference to the performance data 120 to thereby specify the tone that belongs to a category.

Alternatively, a sound signal may have an address at which attribute information and category information are stored. In such a case, the designation unit 131 makes reference to the performance data 120 to thereby acquire the address at which the attribute information and category information are stored. The designation unit 131 makes reference to the acquired address to thereby specify the category to which a tone belongs. Alternatively, the designation unit 131 makes reference to the address to thereby specify the tone that belongs to a category.

Furthermore, in the embodiment described above, musical instrument categories are used, but the present disclosure is not limited to this example. Categories may be set arbitrarily. For example, two categories, vocal and non-vocal categories may be set, or two categories, electric and acoustic categories may be set.

All or part of the sound output device 1 in the embodiment described above may be implemented by means of a computer. In such a case, a program for implementing this function may be recorded on a computer-readable recording medium, and the program recorded on the recording medium may be read into a computer system and executed. It should be noted that the “computer system” herein includes an operating system and hardware units such as peripheral devices. Moreover, the “computer-readable recording medium” here refers to a portable medium such as a flexible disk, a magnetic optical disk, a ROM, and a CD-ROM, or a memory storage device such as a hard disk built in a computer system. Furthermore, the computer-readable recording medium” may refer to those that dynamically store programs for a short period of time, such as communication lines used for transmitting programs using networks such as the Internet and communication lines such as telephone lines. It may also include a volatile memory inside a computer system serving as a server or a client, which holds programs for a certain period of time. The program mentioned above may be a program for implementing a part of the functions described above, and may be a program capable of implementing the functions described above in combination with a program already recorded in a computer system. The program may also be implemented using a programmable logic device such as an FPGA.

Several embodiments of the present disclosure have been described. However these embodiments are presented by way of example and are not intended to limit the scope of the disclosure. These embodiments can be implemented in various other forms, and various omissions, substitutions, and changes can be made without departing from the gist of the disclosure. These embodiments and modifications thereof are included within the scope and gist of the disclosure as well as within the scope of the disclosure described in the claims and its equivalents.

The present disclosure may be applied to a sound generation device, a sound generation method, and a recording medium.

According to the present disclosure, it is possible to search for a sound signal corresponding to the sound of a musical instrument, from performance data in which each of a plurality of tracks includes one or more sound signals each having attribute information. Therefore, settings of automatic performance can be easily changed depending on the band members who are available to participate in a performance.

What is claimed is:

1. A sound generation device comprising:
at least one memory storing instructions; and
at least one processor that executes the instructions to:
output an output sound signal representing a performance based on performance data including a plurality of tracks each including at least one sound signal including an attribute;
designate attribute information of the attribute of at least one of the at least one sound signal of at least one of the plurality of tracks as a search target; and
search for a sound signal including the designated attribute information from the performance data,
wherein the performance in the output sound signal includes, omits, or changes the searched sound signal.

2. The sound generation device according to claim 1, wherein the at least one processor executes the instructions to:
specify a category to which the designated attribute information belongs, based on a correspondence relationship between the designated attribute information and the category; and
search for the sound signal including the attribute information belonging to the specified category.

3. The sound generation device according to claim 2, wherein the at least one processor executes the instructions to select whether to search for the sound signal including:
the designated attribute information; or
the attribute information belonging to the specified category.

4. The sound generation device according to claim 1, wherein the at least one processor executes the instructions to mute the searched sound signal.

5. The sound generation device according to claim 1, further comprising:
a display configured to selectably display an icon indicating a category to which the attribute information belongs,
wherein the at least one processor executes the instructions to designate the attribute information belonging to the category indicated by the icon selected by a user.

6. The sound generation device according to claim 5, wherein the at least one processor executes the instructions to:
control the display to selectably display an image indicating the attribute information belonging to the category indicated by the selected icon in a state where the icon is selected by the user; and
designate the attribute information indicated by the image selected by the user.

7. The sound generation device according to claim 5, wherein the at least one processor executes the instructions to control the display to selectably display a history of the attribute information selected as a previous search target.

8. The sound generation device according to claim 7, wherein the at least one processor executes the instructions to:
control the display to display a button; and
in response to the attribute information being selected by the user and the button being pressed, store the selected attribute information as search target data associated with the button.

9. The sound generation device according to claim 8, wherein storing the selected attribute information comprises:
in response to the button being pressed, making reference to the search target data; and
when search target is not stored in the search target data, storing the selected attribute information as search target data.

10. The sound generation device according to claim 8, wherein storing the selected attribute information comprises:
in response to the button being pressed, making reference to the search target data; and
when search target is stored in the search target data, causing the user to select (i) overwriting and storing the selected attribute information as the search target data or (ii) setting the search target recalled from the search target data as the selected attribute information.

11. A sound generation method executed by a computer, the method comprising:
outputting an output sound signal representing a performance based on performance data including a plurality of tracks each including at least one sound signal including an attribute;
designating attribute information of the attribute of at least one of the at least one sound signal of at least one of the plurality of tracks as a search target; and
searching for a sound signal including the designated attribute information from the performance data,
wherein the performance in the output sound signal includes, omits, or changes the searched sound signal.

12. A non-transitory computer-readable recording medium that stores a program executable by a computer to execute a method comprising:
outputting an output sound signal representing a performance based on performance data including a plurality of tracks each including at least one sound signal each including an attribute;
designating attribute information of the attribute of at least one of the at least one sound signal of at least one of the plurality of tracks as a search target; and
searching for a sound signal including the designated attribute information from the performance data,
wherein the performance in the output sound signal includes, omits, or changes the searched sound signal.
